(19) United States
(12) Patent Application Publication
(10) Pub. No.: US 2004/0060962 A1
(43) Pub. Date: Apr. 1, 2004

(54) Method of joining surfaces

(76) Inventor: David Jacobson, Wembley (GB)

Correspondence Address: HOGAN & HARTSON LLP, ONE TABOR CENTER, SUITE 1500, 1200 SEVENTEENTH ST, DENVER, CO, 80202, US

(21) Appl. No.: 10/381,521

(22) PCT Filed: Mar. 16, 2001
(86) PCT No.: PCT/GB01/01193

(30) Foreign Application Priority Data
Sep. 26, 2000 (GB) 0023559.8

(51) Int. Cl. B23K 35/12

(52) U.S. Cl. 228/56.3; 228/194; 228/245

(57) ABSTRACT

A method of joining surfaces comprising: providing a first surface comprising a layer of silver; interposing between the first surface and a second surface a eutectic composite which melts below 140° C.; raising the temperature of the eutectic composite to a first temperature above the eutectic temperature to at least partially melt the eutectic composite and form molten eutectic alloy; and contacting the molten eutectic alloy with silver layer of the first surface so as to cause inter-diffusion and reaction between the eutectic alloy and the silver, wherein the relative proportions of silver and eutectic composite are selected such that a non-eutectic composition forms between silver and the metals contained in the eutectic composite, the non-eutectic composition having a melting temperature higher than said first temperature.

The present invention relates to a method of joining surfaces. GB 2235642 discloses a method of joining two components involving applying a layer of silver to a first component, and a layer of indium to a second component, and then bringing the layer of silver and the layer of indium together under pressure in a vacuum furnace at a temperature of 175° C. This method relies on the initial formation of an eutectic alloy between the silver and the indium.

According to a first aspect of the present invention, there is provided a method of joining surfaces comprising: providing a first surface comprising a layer of silver; interposing between the first surface and a second surface a eutectic composite which melts below 140° C.; raising the temperature of the eutectic composite to a first temperature above the eutectic temperature to at least partially melt the eutectic composite and form molten eutectic alloy; and contacting the molten eutectic alloy with the silver layer of the first surface so as to cause diffusion of the eutectic alloy into the silver, wherein the relative proportions of silver and eutectic composite are selected such that a non-eutectic composition forms between silver and the metals contained in the eutectic composite, the non-eutectic composition having a melting temperature higher than said first temperature.

One way to ensure that the molten eutectic alloy diffuses into the silver is to provide a protective flash on the outer surface of the eutectic composite, and to carry out the joining process in a non-oxidising environment under an applied pressure of at least 1 MPa. An applied pressure in the range of 2 to 5 Mpa is usually sufficient. The protective flash is a thin layer (generally no more than about 0.5 μm) of silver or a non-oxidising metal such as gold which will dissolve into the molten eutectic alloy. In this preferred embodiment, the contact between the molten eutectic alloy and the silver layer provided on the first surface takes place after the protective flash has dissolved into the molten eutectic alloy.

The eutectic composite can be secured to the second surface to join the first and second surfaces in a number of ways. For example, it can be secured to the second surface before it is joined to the first surface. For example, the layer or layers composing the eutectic composite may be deposited on the second surface by a physical vapour deposition process such as sputtering or laser ablation, a chemical vapour deposition process or electroplating. According to a preferred embodiment, the eutectic composite is deposited on the second surface, the first and second surfaces are then brought together so as to interpose the eutectic composite between the first and second surfaces followed by heating. The eutectic composite is preferably deposited on a layer of silver provided on the second surface.

Alternatively, the second surface could also be provided with a layer of silver and the eutectic composite provided as a discrete component which is then sandwiched between the layers of silver on the first and second surfaces such that on heating to the appropriate temperature, the molten eutectic alloy diffuses into the silver layers on both the first and second surfaces to join the first and second surfaces. In this case, the eutectic composite can for example be provided in the form of a soldering foil comprising a base foil coated with the eutectic composite.

According to a preferred embodiment, the eutectic composite comprises a combination of metals in eutectic proportions selected from the group of tin/indium, gallium/indium, gallium/tin and tin/gallium/indium.

The eutectic composite may comprise discrete layers of each metal in the combination, or it may comprise a single layer of an alloy of the metals in the combination.

According to one embodiment, the eutectic composite comprise a stack of a layer of indium and a layer of tin, the ratio of the thickness of the layer of indium and the layer of tin being in the range of 44:56 to 77:23, preferably in the range of 44:56 to 58:42. Alternatively, it may comprise a single layer of an alloy of indium and tin in corresponding atomic proportions.

According to another embodiment, the eutectic composite consists of tin and gallium with an atomic percentage of tin up to 93%, preferably up to 60%.

In another embodiment, the eutectic composite consists of indium and gallium with an atomic percentage of indium up to 82%.

The method according to the present invention can be used, for example, to join two components together. Each of the components may be made of organic, ceramic or metal materials, including alloy materials.

The first surface is preferably provided with a layer consisting substantially of silver.

According to a second aspect of the present invention, there is provided a method of joining two surfaces comprising the steps of: providing a first surface comprising a first layer of silver; providing a second surface comprising a second layer of silver; interposing a soldering foil between the first and second layers of silver, the soldering foil comprising a base foil having a layer of silver with a thickness of at least 5 μm and further coated with indium; contacting the soldering foil with the first and second layers of silver at a first temperature sufficient to initially cause formation of a silver-indium eutectic alloy and then subsequent reaction of the eutectic alloy with silver in the first and second layers, wherein the relative proportions of silver and indium are selected such that a non-eutectic composition forms as a result of the reaction between the silver and the eutectic alloy, the non-eutectic composition having a melting point higher than said first temperature.

As discussed above, one way to ensure that the silver-indium eutectic alloy is formed and then reacts with the silver in the first and second layers is to provide the outer surface of the indium coating with a protective flash, and to carry out the joining process in a non-oxidising environment under an applied pressure of at least 1 Mpa. An applied pressure in the range of 2 to 5 Mpa is usually sufficient. The protective flash is a thin layer (generally no more than about 0.5 μm) of silver or a non- oxidising metal such as gold.

The base foil may, for example, be a silver foil or a copper foil coated with a layer of silver to a thickness of at least 5 μm.

The relative proportions of indium to silver should be selected to provide a silver-rich non-eutectic composition. According to one embodiment, the volume of silver is about 77% of the total volume of silver and indium.

The first and second surfaces are preferably provided with layers consisting substantially of silver.

The use of the soldering foil according to the present invention has a number of advantages over the method disclosed in GB2235642. For example, it allows two surfaces to be joined reliably over a relatively large surface area, and-the base foil also functions as a stress-relief layer after the two surfaces have been joined.

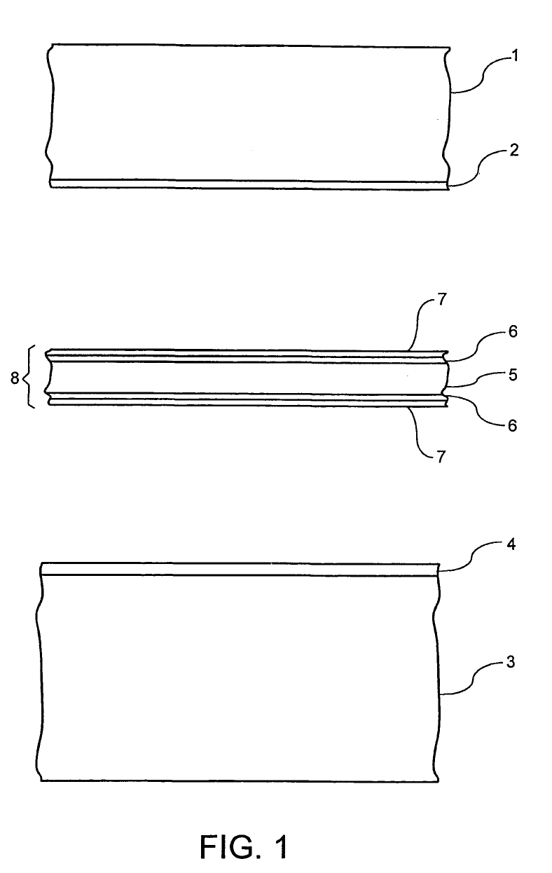

Embodiments of the present invention shall now be described hereunder, by way of example only, with reference to the accompanying drawing, in which FIG. 1 illustrates a method according to a first embodiment of the present invention.

With reference to FIG. 1, a method for attaching a sapphire wafer to the stainless steel cold-head of a cooler is described below.

A silver plate is brazed to the stainless steel cold head (not shown), and the rear side of the sapphire wafer 1 is provided with a 5 μm coating of silver 2 by sputter-metallisation via a bonding layer (not shown) of nichrome, titanium etc. A machined and lapped carrier disc 3 of Si40Al or Cu-75W (2-3 mm thick) is plated with a 5 μm layer of silver 4 via layers of copper and nickel (not shown). A silver foil 5 of 50 μm thickness is plated with a layer of indium 6 to a thickness of 3 μm followed by a 0.5 μm flash of silver 7 to produce the soldering foil 8. The solder foil 8 is sandwiched between the silver coating 2 on the rear side of the sapphire wafer 1 and the silver layer 4 on the carrier disc 3, and diffusion soldering is carried out at 175-200° C. for 1 minute under a uniaxial pressure of 3 MPa. The wafer/carrier sub-assembly is then clamped to the silver termination on the cold-head using screws tightened to a torque of 1.5 N.m (uniformly distributed).

Alternatively, the joining operation may be carried out at a lower temperature (140-170° C.) by using a soldering foil comprising a silver foil coated with 1.5 micron layers of indium and tin sequentially, in any order. Again, a 0.5 micron flash of silver (or gold) is provided on the outer surface.

1. A method of joining surfaces comprising:
providing a first surface comprising a layer of silver;
interposing between the first surface and a second surface a eutectic composite which melts below 140° C.;
raising the temperature of the eutectic composite to a first temperature above the eutectic temperature to at least partially melt the eutectic composite and form molten eutectic alloy;
and contacting the molten eutectic alloy with the silver layer of the first surface so as to cause interdiffusion and reaction between the eutectic alloy and the silver, wherein the relative proportions of silver and eutectic composite are selected such that a non-eutectic composition forms between silver and the metals contained in the eutectic composite, the non-eutectic composition having a melting temperature higher than said first temperature.

2. A method according to claim 1 wherein the eutectic composite comprises a combination of metals in eutectic proportions selected from tin/indium, gallium/indium, gallium/tin and tin/gallium/indium.

3. A method according to claim 1 or claim 2 wherein the eutectic composite consists of discrete layers of each component in the composite.

4. A method according to claim 2 wherein the eutectic composite comprises an alloy of the components in the composite.

5. A method according to any preceding claim wherein the outer surface of the eutectic composite is provided with a protective flash.

6. A method according to any preceding claim wherein the second surface comprises a layer of silver and the eutectic composite is bonded to the silver layer of the second surface.

7. A method according to any preceding claim wherein the eutectic composite comprises a layer of indium and a layer of tin, the ratio of the thickness of the layer of indium and the layer of tin being in the range of 44:56 to 77:23.

8. A method according to claim 7 wherein the ratio of the thickness of the layer of indium and the layer of tin is in the range of 44:56 to 58:42.

9. A method according to any of claims 1 to 6 wherein the eutectic composite comprises tin and gallium with an atomic percentage of tin up to 93%, preferably up to 60%.

10. A method according to any of claims 1 to 6 wherein the eutectic composite comprises indium and gallium with an atomic percentage of indium up to 82%.

11. A method according to any preceding claim wherein the relative proportions of silver and eutectic composite are selected to result in a silver-rich non-eutectic composition.

12. A method of joining two surfaces comprising the steps of:
providing a first surface comprising a first layer of silver;
providing a second surface comprising a second layer of silver;
interposing a soldering foil between the first and second layers of silver, the soldering foil comprising a base foil having a layer of silver with a thickness of at least 5 μm and further coated with indium;
contacting the soldering foil with the first and second layers of silver at a first temperature so as to initially cause formation of a silver-indium eutectic alloy and then subsequent reaction of the eutectic alloy with silver in the first and second layers, wherein the relative proportions of silver and indium are selected such that a silver-rich non-eutectic composition forms as a result of inter-diffusion and reaction between the silver and the eutectic alloy, the non-eutectic composition having a melting point higher than said first temperature.

13. A method according to claim 12 wherein the base foil is a silver foil or a foil of another soft metal coated with silver to a thickness of at least 5 μm.

14. A method according to claim 12 or claim 13 wherein the base foil is a copper foil coated with silver.

15. A method according to any of claims 12 to 14 wherein the indium coating is further coated with a protective flash.

16. A soldering foil comprising a base foil having a layer of silver with a thickness of at least 5 μm and further coated with indium.

17. A soldering foil according to claim 16 wherein the base foil is a silver foil or a foil of another soft metal coated with silver.

18. A soldering foil according to claim 16 or claim 17 wherein the outer surface of the indium coating is further coated with a protective flash.

19. A method of joining surfaces substantially as hereinbefore described with reference to FIG. 1 of the accompanying drawings.

20. A soldering foil substantially as hereinbefore described with reference to FIG. 1 of the accompanying drawings.
